(19) United States
(12) Patent Application Publication
(10) Pub. No.: US 2013/0179309 A1
(43) Pub. Date: Jul. 11, 2013

(54) Methods and Systems For Restocking Inventory

(71) Applicant: Thermo Fisher Scientific Inc., Waltham, MA (US)

(72) Inventors: Steven J. Heil, McMurray, PA (US); Paul S. Sapsara, New Kensington, PA (US)

(73) Assignee: THERMO FISHER SCIENTIFIC INC., Waltham, MA (US)

(21) Appl. No.: 13/737,246

(22) Filed: Jan. 9, 2013

Related U.S. Application Data
(63) Continuation-in-part of application No. 13/346,817, filed on Jan. 10, 2012.

(51) Int. Cl. G06Q 10/08

(52) U.S. Cl. CPC G06Q 10/087
USPC 705/28

(57) ABSTRACT

Methods and systems for restocking inventory. Machine readable code associated with a product that is part of a stockroom inventory is scanned with a mobile device. Based on data in the machine readable code, the mobile device obtains data relating to the product via a wireless network and displays the data to the user. The data may include product images, details, prices, marketing promotions, regulatory or safety media, inventory rules, and other data that is retrieved from an updated database. The mobile device may also populate an order amount window with a desired amount of the product to be ordered based on known and desired inventory levels. Products may be added to an order and the order placed or saved for later submission though the mobile device based on the displayed data.

### CROSS-REFERENCE TO RELATED APPLICATIONS

This application is a continuation-in-part of U.S. Ser. No. 13/346,817, filed Jan. 10, 2012 and entitled “METHODS AND SYSTEMS FOR RESTOCKING INVENTORY”, the disclosure of which is incorporated herein by reference in its entirety.

### FIELD OF THE INVENTION

The present invention relates generally to methods and systems for inventory management and, more particularly, to methods and systems for restocking inventory products that provide real-time product data to system users and reduce the need for manual data entry.

### BACKGROUND OF THE INVENTION

Requisition and inventory management systems traditionally rely on stockroom workers to determine which items need to be restocked. Once the items that need to be restocked are determined, the stockroom worker typically generates a requisition to order the products by entering product data into a requisition system for each product being ordered. These systems typically provide little or no real-time product data to the system user during the ordering process. Thus, the system user must wait until after most or all of the ordering process has been completed before useful real time product data, such as current price and/or availability, is known.

Attempts have been made to improve inventory management systems and increase the availability of real-time product and inventory data by linking various computer systems. One such system is the Fisher Scientific Requisition and Inventory Management System (“Fisher RIMS system”), described in U.S. Pat. No. 5,712,989, the disclosure of which is incorporated herein by reference in its entirety. The Fisher RIMS system includes a local computer at a customer site and a host computer at a distributor site. The local and host computers communicate over a network so that each computer has access to databases containing data related to requisitions and inventory management associated with the other computer. This data is transmitted between the local and host computers when needed, with the receiving local or host computer using the received data to process a requisition or to update inventory records. The Fisher RIMS System thereby enables requisition records to be created from a real-time interaction between the local and host computers, with each computer using data from its respective database in conjunction with data entered by the system user through the local computer. However, while the Fisher RIMS system provides improved data regarding inventory at the customer and distributer sites, system users are still required to determine the amount of product to order and manually enter product data into the system.

Attempts have also been made to develop systems that provide more complete product data to customers. One such system is the Fisher Scientific SupplyLink system (“SupplyLink system”), described in U.S. Pat. No. 6,023,683, the disclosure of which is incorporated herein by reference in its entirety. The SupplyLink system is a sourcing system that manages and searches a database of catalog items contained in at least two vendor product catalogs. Once a desired item is located, the customer may select the item so that data regarding the item is provided to a customer requisition/purchasing system. The customer system can then use this data to generate a requisition that includes the selected catalog items. However, the SupplyLink system still requires users to manually enter part or catalog numbers. Moreover, the SupplyLink system requires the users to determine what items need to be ordered. Thus, ordering products in a stockroom environment remains a largely manual process with the SupplyLink system.

To reduce human error associated with manual entry of data into inventory management systems, handheld scanner devices have been proposed that read barcodes associated with the products in inventory. One such system is described in Singh et al., U.S. Pat. No. 7,823,778, the disclosure of which is incorporated herein by reference in its entirety. Users of the Singh system scan information representing inventory items with scanning devices. The scanned information is then communicated wirelessly to an inventory management system, which updates the inventory database accordingly. Singh thus improves the inventory management process by reducing human error associated with data entry as well as eliminating some reentry of data in various steps of the process. However, Singh fails to improve ordering and requisition generation processes, or provide improved product data to the user.

Therefore, apart from some incremental improvements, the process of restocking inventory has not improved substantially and remains a largely manual process subject to human error. Conventional inventory management systems fail to provide valuable real-time feedback and product data to the end user while the user is working within the process of assembling an order. This lack of real time data prevents system users from adapting their order to take advantage of temporary pricing, inventory availability, and marketing promotions while the user is reviewing and replenishing product inventory levels.

Thus, there is a need for improved methods and systems of requisition and inventory management that save time by reducing the number of steps in the stockroom reordering process and by eliminating multiple points of data entry, and that reduce the potential for human error through manual entry of product data.

### SUMMARY OF THE INVENTION

The present invention overcomes the foregoing problems and other shortcomings, drawbacks, and challenges of restocking products in a stockroom environment. While the invention will be described in connection with certain embodiments, it will be understood that the invention is not limited to these embodiments. To the contrary, this invention includes all alternatives, modifications, and equivalents as may be included within the spirit and scope of the present invention.

In one embodiment of the invention, a method is provided for replenishing product inventory in a stockroom. The method includes, in response to a first input into a user interface of a mobile device, scanning a machine readable code associated with a product with the mobile device to identify the product. The method further includes determining a desired inventory amount based at least in part on data contained in the machine readable code.

In another embodiment of the invention, a requisition and inventory management system is provided for restocking inventory. The system includes a processor and a memory. Stored in the memory are instructions that, when executed by the processor, cause the processor to, in response to a first input into a user interface of a mobile device, scan a machine readable code associated with a product to identify the product. The instructions further cause the processor to determine a desired inventory amount based at least in part on data contained in the machine readable code.

In another embodiment of the invention, a computer program product is provided. The computer program product includes a non-transitory computer readable storage medium and program instructions stored on the computer readable storage medium. When executed by a processor, the program instructions cause the processor to, in response to a first input into a user interface of a mobile device, scan a machine readable code associated with a product to identify the product. The instructions further cause the processor to determine a desired inventory amount based at least in part on data contained in the machine readable code.

Embodiments of the invention thereby provide valuable real-time feedback and product data to the end user while the user is working within the process of reordering products. This data may include the end user's business or inventory rules—such as minimum and maximum stock amounts—as well as dynamic product marketing opportunities, such as promotions, based on the products that are being restocked during the restocking process. This data is provided to the user through the user interface on the wireless device so that the data is available in real-time while current inventory levels are being assessed.

By providing real-time product data, pricing, inventory availability, and marketing promotions while the user is in the process of reviewing and replenishing product inventory levels, embodiments of the invention improve the stockroom reordering process. The scanning function reduces human error and saves time by eliminating multiple points of data entry—effectively reducing the entry of potentially complex product SKU numbers to a single scan of a product code. Additionally, embodiments of the invention reduce the number of steps necessary for a stockroom reordering process as compared to conventional systems, because the user is not required to manually create and submit an order based on the results of an inventory review.

### BRIEF DESCRIPTION OF THE DRAWINGS

The accompanying drawings, which are incorporated in and constitute a part of this specification, illustrate embodiments of the invention and, together with a general description of the invention given above, and the detailed description of the invention given below, serve to explain the principles of the invention.

FIG. 1 is a schematic block diagram illustrating a mobile device, e-business platform, and a product inventory system in communication via wireless and core data networks in accordance with an embodiment of the invention.

FIG. 2 is a flow chart illustrating interactions between a system user, a mobile application on the mobile device, the e-business platform, and product inventory system in accordance with an embodiment of the invention.

FIG. 3 is an illustration of a screen shot showing a home page displayed by the mobile application in accordance with an embodiment of the invention.

FIG. 4 is an illustration of a screen shot showing a product page displayed by the mobile application in accordance with an embodiment of the invention.

FIG. 5 is an illustration of a screen shot showing a login page displayed by the mobile application in accordance with an embodiment of the invention.

FIG. 6 is an illustration of a screen shot showing a product page displayed by the mobile application in accordance with an embodiment of the invention.

FIG. 7 is an illustration of a screen shot showing a scanned item list page displayed by the mobile application in accordance with an embodiment of the invention.

FIG. 8 is an illustration of a screen shot showing an order summary and review page displayed by the mobile application in accordance with an embodiment of the invention.

FIG. 9 is an illustration of a screen shot showing the order summary and review page of FIG. 8 with a pop-up confirmation window displayed by the mobile application in accordance with an embodiment of the invention.

FIG. 10 is an illustration of a screen shot showing a previous order page displayed by the mobile application in accordance with an embodiment of the invention.

### DETAILED DESCRIPTION OF THE PREFERRED EMBODIMENT

Embodiments of the invention provide methods and systems of restocking products in a stockroom environment. To this end, a mobile application allows users to order restock inventory while the user is at the point of storage using a mobile device, such as a smart phone or tablet computer. To assemble an order, users capture product codes included on the products or in proximity to where the products are stored using the mobile device. Based on data associated with, or embedded in the product code, data regarding the item is obtained by the mobile application and displayed to the user. This data may include recommended minimum and maximum inventory levels, prices, product availability, and product promotions. The user may then add a desired number of the items the order.

Once the order is completed, the user submits the order over the user interface provided on the mobile device, or saves the order for later submission. The system is thus ideal for restocking product bins and inventory management in a stockroom environment. Product images, details, prices, marketing promotions, regulatory or safety media, local stockroom or inventory rules (such as minimum and maximum inventory levels), and other data are retrievable in real-time from remote databases and delivered to the end user via the mobile device at various steps of the process. This real time data allows the user to make intelligent decisions regarding the order as the order is assembled. The real time interaction provided by the mobile application thereby facilitates adjusting the order to, for example, take advantage of product promotions, order substitute products for items that are out of stock, or otherwise optimize the order as the order is placed.

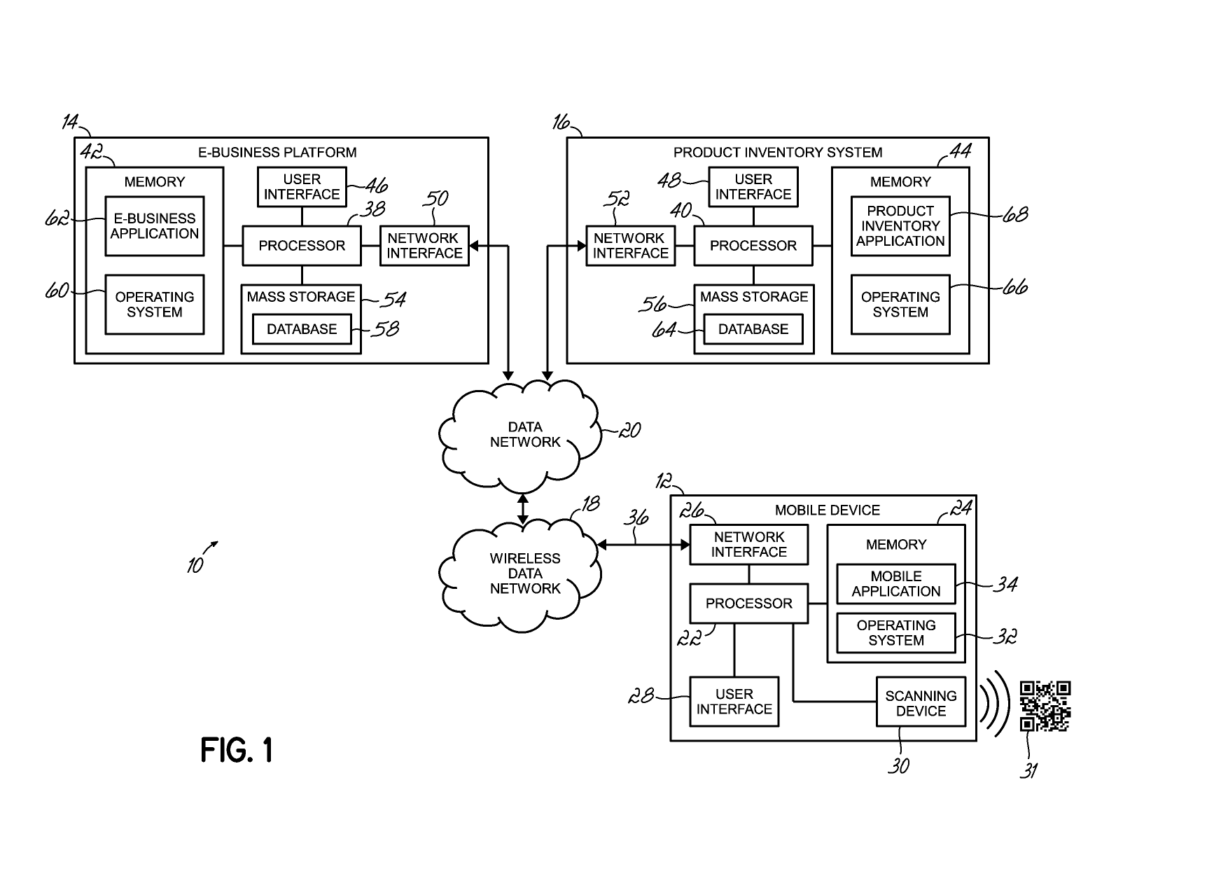

Referring now to FIG. 1, and in accordance with one embodiment of the present invention, a restocking system 10 includes a mobile device 12, an e-business platform 14, a product inventory system 16, a wireless data network 18, and a core data network 20. The core data network 20 may include one or more local access networks (LANs) as well as a publically accessible network, such as the Internet, and is operatively coupled to the wireless data network 18. The wireless data network 18 and core data network 20 thereby provide communication links between the mobile device 12, the e-business platform 14, and the product inventory system 16.

According to one aspect of the present invention, the wireless data network 18 includes a wireless access point (not shown). The wireless access point provides a wireless interface, such as an IEEE 802.11 air interface (commonly known as Wi-Fi) that operatively couples the mobile device 12 to the wireless data network 18. The wireless data network 18 thereby allows the mobile device 12 to establish a communication link as needed with the e-business platform 14 and/or product inventory system 16 without requiring the mobile device 12 be tethered to a computer. In an alternative embodiment, the wireless network 20 may be provided by a wireless carrier that provides access through a suitable commercial air interface, such as WiMax, GPRS, EDGE, 1xRTT, EV-DO, and/or UMTS. In any case, persons having ordinary skill in the art of wireless networking will understand that any suitable wireless protocol may be employed to provide communication between the mobile device 12 and the wireless data network 18, and the invention is not limited to a specific type of wireless data network or associated air interface.

The mobile device 12 includes a processor 22, a memory 24, a network interface 26, a user interface 28, and scanning device 30. The processor 22 may include one or more processors selected from microprocessors, micro-controllers, digital signal processors, microcomputers, central processing units, field programmable gate arrays, programmable logic devices, state machines, logic circuits, and/or any other devices that manipulate signals (analog and/or digital) based on operational instructions that are stored in memory 24. Memory 24 is operatively coupled to the processor 22, and may be a single memory device or a plurality of memory devices including but not limited to read-only memory (ROM), random access memory (RAM), volatile memory, non-volatile memory, static random access memory (SRAM), dynamic random access memory (DRAM), flash memory, cache memory, and/or any other device capable of storing data.

Processor 22 may operate under the control of an operating system 32 that resides in memory 24. When present, the operating system 32 manages mobile device resources so that program code embodied as a mobile application 34 residing in memory 24 may have instructions executed by the processor 22. In an alternative embodiment, the mobile application 34 may be executed by the processor 22 directly, in which case the operating system 32 may be omitted.

The user interface 28 is operatively coupled to the processor 22 of mobile device 12 and includes at least one output device and one input device. Suitable output devices for the mobile device 12 include, but are not limited to, a touch screen, an alphanumeric display, an audio transducer, and/or any other visual, audible, and/or tactile indicator. Likewise, suitable input and/or control devices include, but are not limited to, the aforementioned touch screen, an alphanumeric keyboard or keypad, a pointing device, pushbuttons, a microphone, and/or any other device capable of accepting commands or input from the user and transmitting the entered input to the processor 22. The user interface 28 thereby provides a mechanism whereby a user may input data to, and receive data from the processor 22.

The mobile device 12 also includes a scanning device 30 configured to scan a label containing machine readable code 31. These labels are commonly referred to as barcodes (in the case of a 1-dimentional code) or quick response (QR) codes (in the case of a 2-dimentional code). To this end, the scanning device 30 may include a light source, such as a laser, that illuminates the machine readable code 31 and a photo detector that generates an electrical signal in response to light reflected from the code. The scanning device 30 may, in addition to or instead of the light source and photo detector, include an image capturing device that captures images representative of the surrounding environment. These captured images may be processed into any suitable digital image file format known in the art, such as a raw image file, bit map, or Joint Photographic Experts Group (JPEG) formatted image (to name but a few) by the processor 22 and stored in memory 24. A digital image processing technique may then be used by the mobile application 34 to decode any machine readable code 31 that appears in the captured image.

The labels containing the machine readable code 31 may be affixed to the products themselves, to a requisition list, or otherwise provided to the system user. However, in a typical stockroom environment, the labels may be affixed to a structure located an area in the stockroom where an associated product is stored, such as a shelf or bin. Locating the label in the stockroom allows the machine readable code to be scanned when the product is out of stock. Locating the label in the stockroom also allows data specific to that stockroom to be stored on the label, such as recommended minimum and maximum inventory levels for particular products stored in the stockroom.

The network interface 26 includes suitable radio transceiver circuitry that enables a wireless communication link 36 between the mobile device 12 and the wireless data network 18. A communication path is thereby provided which allows the mobile application 34 to exchange data with the e-business platform 14 and product inventory system 16 without being tethered by a wire or cable. The e-business platform 14 and product inventory system 16 typically comprise program code running on a computer such as a personal computer, a work station, or mini-computer that operates as a server to support corresponding e-business and product inventory platform functions. Although illustrated as separate systems in FIG. 1, it should be understood that the e-business platform 14 and product inventory system 16 may also be integrated into a single program and/or include multiple programs running on a single hardware platform.

Similarly as described with respect to the mobile device 12, the e-business platform 14 and product inventory system 16 each include one or more processors 38, 40, memories 42, 44, user interfaces 46, 48, and network interfaces 50, 52, respectively. The network interfaces 50, 52 provide communication links between their respective processors 38, 40 and the data network 20 using a suitable network communication protocol, such as Transmission Control Protocol/Internet Protocol (TCP/IP) over Ethernet.

The user interfaces 46, 48 each include suitable output devices, such as a color monitor or other visual display, one or more speakers, one or more formatted electronic media writers, such as a flash memory card, memory stick, USB-stick, CD, magnetic disk, and/or any other suitable output devices capable of storing data or conveying data to the system user. The user interfaces 46, 48 also include suitable input devices such as an alphanumeric keyboard, a pointing device or mouse, a touch pad, a microphone, one or more readers of the aforementioned formatted electronic media, or any other input devices capable of accepting commands or input from the user and transmitting the entered input to the associated processor 38, 40.

The e-business platform 14 and product inventory system 16 may also include mass storage devices 54, 56. The mass storage devices 54, 56 may each comprise a single mass storage device or a plurality of mass storage devices including but not limited to hard drives, optical drives, tape drives, non-volatile solid state devices and/or any other device capable of storing digital data.

The e-business platform 14 may comprise a version of the previously described SupplyLink system, or some other suitable e-business system, and includes an e-business database 58 residing in mass storage device 54. The e-business database 58 may include data regarding products from one or more vendor product catalogs so as to provide a searchable product database that covers multiple vendors. Data typically maintained by the e-business database 58 may include the product part number, product price, promotions related to the product, product catalog number, vendor name or I.D., and vendor catalog number, as well as textual data and images of or relating to the product. The e-business database may also include inventory rules, such as recommended minimum and maximum inventory levels. The inventory rules may be specific to the customer that is ordering the product so that the rules reflect the needs of the customer placing the order. The types of products carried by the distributor supported by the e-business platform 14 will typically determine which product catalogs are made a part of the e-business database 58. The e-business database 58 is therefore not limited to a particular type of product, and may include multiple databases 58, such as requisition databases, inventory databases, and customer specific databases (such as an inventory rules database) configured to support a specific mobile application user.

The e-business platform processor 38 typically operates under the control of an operating system 60 that resides in memory 42 and executes program code embodied as one or more e-business applications 62 residing in memory 42. The one or more e-business applications 62 may include a requisition/purchasing program, a database search program, shell programs, and a graphic user and/or machine-machine interface program for listing and updating product data. These applications 62 may access the e-business database 58 and provide data to the mobile application 34 in response to requests received over the data network 20. One or more of these applications 62 may also be copied from the e-business platform 14 to another memory 24, 44 as needed to perform functions related to the operation of the restocking system 10.

The product inventory system 16 may comprise a version of the previously described Fisher RIMS system or some other suitable requisition/purchasing system. In a similar fashion as described with respect to the e-business platform 14, the product inventory system 16 may include a plurality of program modules and databases that support requisition and purchasing functions. To this end, a product inventory database 64 may reside in mass storage device 56. The product inventory database 64 may include multiple databases such as one or more requisition databases, inventory databases, and/or customer-specific databases, such as the aforementioned inventory rules database. Database 64 may thereby include data regarding quantities of products available at one or more distributor warehouses or locations, and records for each product sold by the distributor in question. Each product record may, in turn, include data such as the distributor's catalog or part number for the product, the product's list price, current product cost, the supplier or vendor for the product, a code identifying the product as part of a product grouping to be treated similarly for customer discounting purposes, and inventory rules that include the desired or recommended minimum and maximum inventory levels at the customer location.

The storage of data regarding inventory rules is not limited to a particular storage location or database, and said data may be stored in one or more of the machine readable code 31, e-business database 58, product inventory database 64, or any other suitable location. Database 64 may also include discount records by customer that enable the product inventory application 68 or other restocking system program to calculate a price for a particular product based at least in part on the particular customer using the mobile application 34. Database 64 may further contain cross-references from the distributor's catalog number to the product vendor's part number and to similar catalog numbers of other suppliers or distributors for the same product. These cross-references may be contained as either a part of the item record, in a separate cross-reference file, or both.

As with the e-business platform 14, the product inventory system processor 40 typically operates under the control of an operating system 66 that resides in memory 44 and executes program code embodied as one or more product inventory applications 68 residing in memory 44. The product inventory application 68 will typically control all inventory, pricing and requisitioning operations of the distributor's products using the product inventory database 64, which may be comprised of more than one database. The product inventory application 68 may also include a requisition/purchasing program, a database search program, a shell program, and a graphic user and/or machine-machine interface program for listing and updating product data. As with the e-business applications 62, one or more of these programs 68 may also be copied from the product inventory system 16 when needed by another application or system.

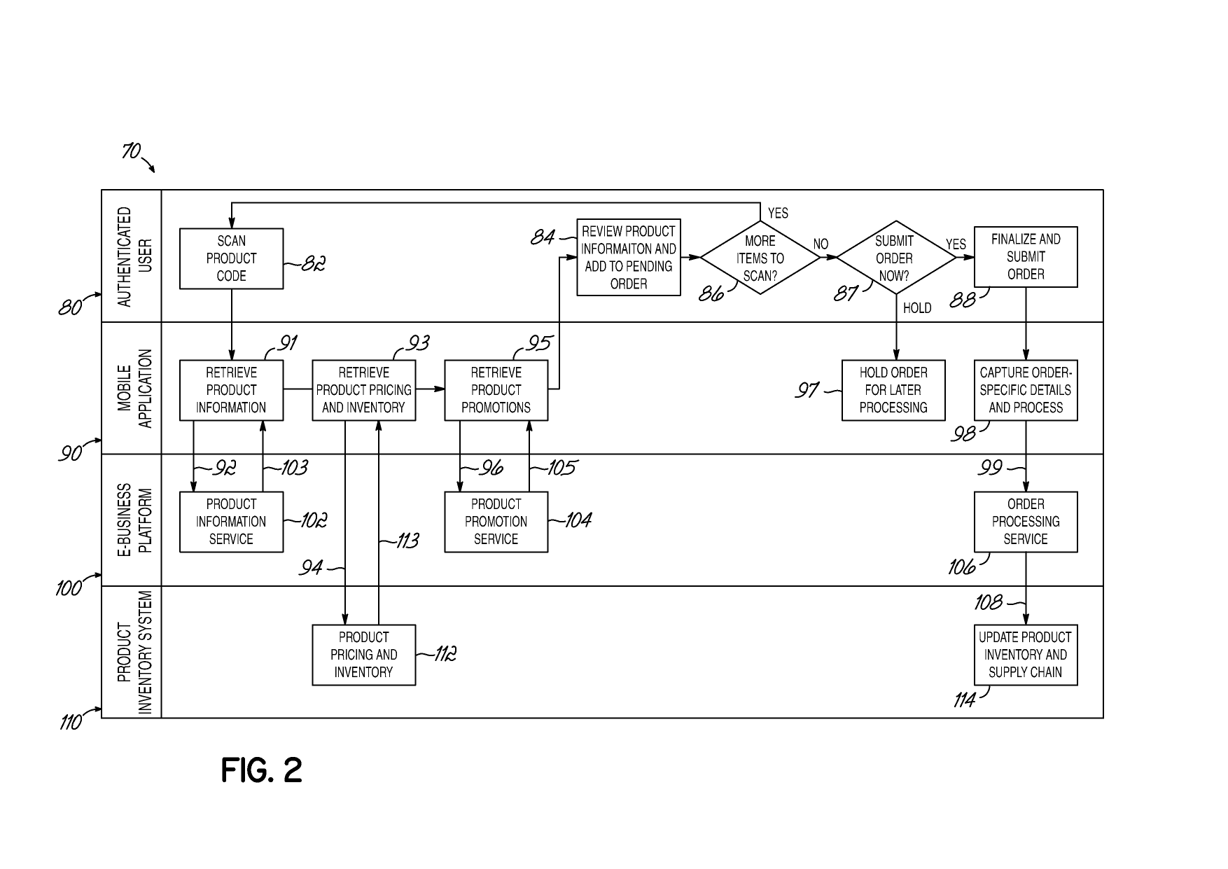

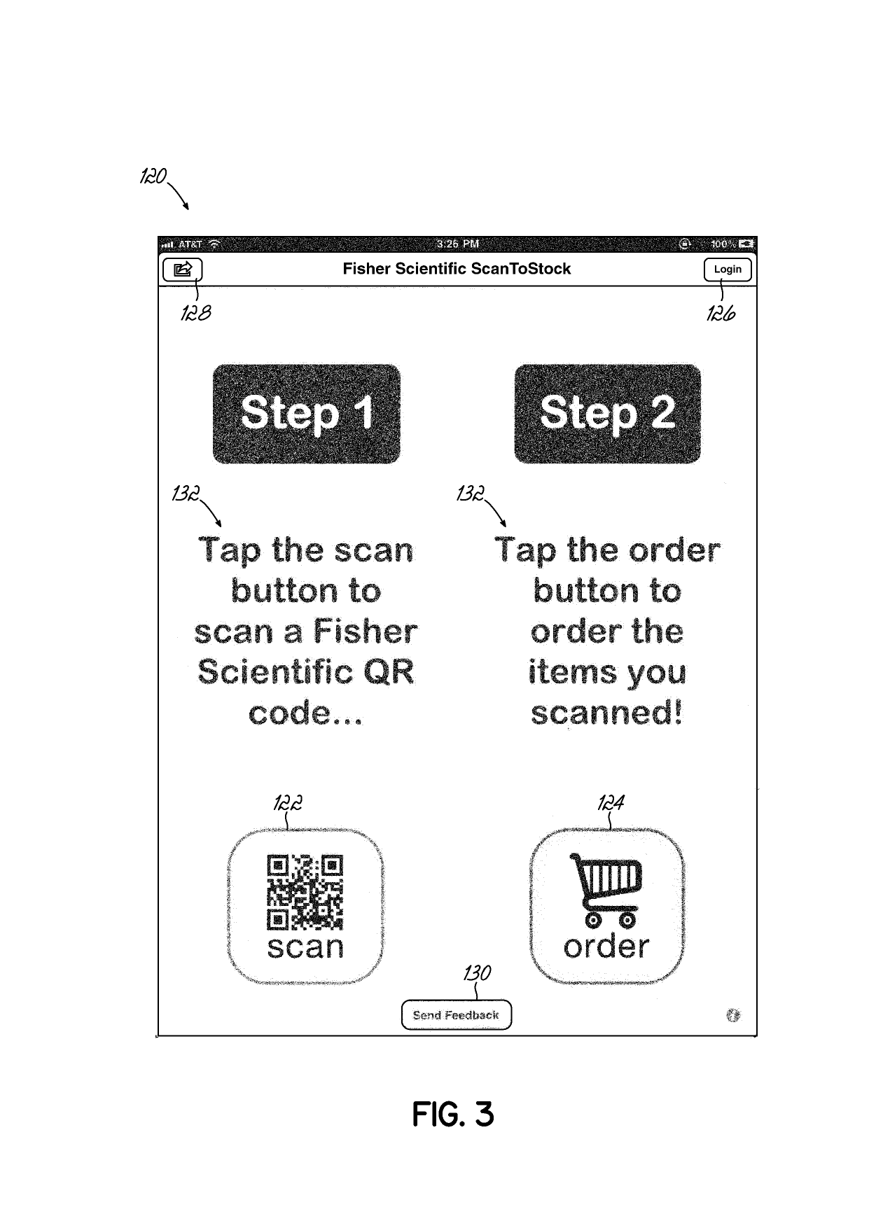

Referring now to FIGS. 2-10, FIG. 2 presents a flow chart 70 for assembling an exemplary order using restocking system 10, and FIGS. 3-10 provide corresponding screen shots that illustrate how the system user interacts with the user interface 28 of mobile device 12. The function blocks in row 80 of FIG. 2 illustrate actions taken by the system user, function blocks in row 90 represent functions performed by the mobile application 34, function blocks in row 100 represent functions performed by the e-business application 62, and function blocks in row 110 represent functions performed by product inventory application 68. It should be understood, however, that the arrangement of functions shown in FIG. 2 is for exemplary purposes only. Persons having ordinary skill in the art will understand that in alternative embodiments of the invention, some of these functions could be reallocated between the mobile application 34, e-business application 62, and product inventory application 68. In addition, one or more of the applications, such as the e-business platform and product inventory system, could be integrated on a single system or platform. Moreover, persons having ordinary skill in the art will further understand that the databases 58, 64 may include data stored in one or more of the e-business platform 14, product inventory platform 16, on servers in the data network 20 (e.g., in what is commonly referred to as “the cloud”), and/or in the machine readable code 31. In particular, data regarding inventory rules such as minimum and maximum inventory levels may be stored in any of the aforementioned locations for retrieval by the mobile application 34. Data may also be cached in the mobile device 12 to facilitate operation of the mobile application 34. Embodiments of the invention are therefore not limited to the structure illustrated in FIG. 2.

Referring to FIG. 3, in response to the user activating the mobile application 34, the user may be presented with a top level or home page 120 that includes a product scan button 122, an order button 124, a login button 126, a return button 128, a feedback button 130, as well as text 132 describing the functions of one or more of the buttons 122, 124. From this point, the user may opt to log into an account by activating login button 126, or may begin assembling an order before logging in by scanning a product label containing machine readable code 31. In an alternative embodiment of the invention, the user may be required to log into an active account before they are granted access to the restocking system 10. In this alternative embodiment, the user would be unable scan items until after they logged into the system 10.

Referring now to the flow chart 70 in FIG. 2, in block 82, the user scans a product code by aiming the scanning device 30 in the direction of machine readable code 31 associated with a product of interest. Once the mobile device 30 is in position, the user taps or otherwise activates the scan button 122. To assist the user in aiming the mobile device 30, an image may be displayed on the user interface 28 of the mobile device 30 representative of the region captured by the scanning device 30. The user may thereby accurately capture the machine readable code 31 for the desired product.

In response to activation of the scan button 122, the mobile application 34 proceeds to block 91, which causes scanning device 30 to capture the machine readable code 31. Once captured, the mobile application 34 extracts data from the machine readable code 31 that uniquely identifies the product in question. The machine readable code 31 may also contain other data relating to the product, such as the desired minimum and maximum inventory levels, and/or other inventory rules for the stockroom in which the machine readable code 31 is located.

The mobile application 34 transmits a first query 92 that includes the product identifying data to the e-business platform 14 via the data networks 18, 20. The e-business application 62 receives the first query 92, and in response, proceeds to product information service block 102. In block 102, the e-business application 62 transmits a database query to the e-business database 58. In response to the database query, the e-business database 58 retrieves data representing information related to the product in question. This data may include one or more images related to the product as well as text describing the product, and is provided to the e-business application 62 in a database query response. In some embodiments of the invention, the data retrieved from the e-business database 58 may include inventory rules, such as the desired minimum and maximum inventory levels at the customer site. The e-business application 62 uses the product data in the database query response to generate a first query response 103. The first query response 103 may be in any suitable machine readable format, such as Extensible Markup Language (XML). Once generated, the first query response 103 is sent to the mobile device 12 over the data networks 18, 20 where it is received by the mobile application 34.

The mobile application 34 then proceeds to block 93, where the mobile application 34 launches a second query 94 to the product inventory system 16 that requests product pricing and inventory data. The second query 94 may include data obtained by the mobile application 34 from the e-business platform 14 in the first query response 103, and/or product identification data obtained from the machine readable code 31. The product inventory application 68 receives the second query 94, and in response proceeds to block 112. In block 112, the product inventory application 68 transmits a database query to the product inventory database 64. In response to the database query, the product inventory database 64 retrieves data related to the product in question. This data may include real-time data regarding the product price, availability, location, and potential shipping dates, and is provided to the product inventory application 68 in a database query response. In a similar manner as previously described with respect to the first query response 103, this data is formatted by the product inventory application and sent to the mobile device 12 in a second query response 113. In some embodiments of the invention, the data retrieved from the product inventory database 64 may include inventory rules, such as the desired minimum and maximum inventory levels at the customer site. Typically, the inventory rules data will be located in one of the machine readable code 31, e-business database 58, or product inventory database 64. However, embodiments of the invention are not so limited. That is, inventory rule data may be located in any combination of the machine readable code 31, e-business database 58, product inventory database 64, and/or a storage location in the network 20.

The mobile application 34 then proceeds to block 95 where the mobile application 34 determines whether to transmit a third query to the e-business platform. To this end, the mobile application 34 may analyze the data received in one or both of the first and second query responses 103, 113 to determine if a predetermined condition is met. Typically, this predetermined condition relates to the existence of a promotion that is associated with the scanned product. The condition is typically met based on data received from the product inventory system 16, such as a set promotion flag in the second query response 113. For example, if the product is flagged as discontinued in the second query response 113, then the mobile application 34 may determine that no additional queries to the e-business platform 14 are necessary. In an alternative embodiment of the invention, if the product is flagged as discontinued in the second response 113, the mobile application 34 may be configured to transmit additional queries to the e-business platform 14 to find substitute products to display to the user. The mobile application 34 is thus configurable based on the needs of the customer to make decisions about obtaining and displaying additional data through subsequent queries based on data received in previous responses. As a specific example, if the mobile application 34 determines that no inventory rules are provided by machine readable code 31, the mobile application may query one or more of the e-business database 58 and/or product inventory database 64 for inventory rules, such as the desired minimum and maximum inventory levels.

If an additional query is necessary, the mobile application 34 launches a third query 96 to the e-business platform 14. The third query 96 may include data received in the second query response 113, other customer and product data received in previous responses, or data that is otherwise accessible by the mobile application 34. In response to receiving the third mobile application query 96, the e-business application 62 proceeds to block 104.

In block 104, the e-business application 62 transmits a database query to the e-business database 58 requesting data on relevant product promotions. In response to this database query, the product inventory database 58 retrieves promotion data related to the product in question. These promotions may be associated with the scanned product, the customer ordering the product, products related to the scanned product, and may include marketing information determined to be of interest to the customer based on the product being ordered, a customer profile, or both.

Once the mobile application 34 has acquired the necessary data from the e-business platform 14 and product inventory system 16, the mobile application 12 proceeds to block 84 and displays the data on the user interface 28 of the mobile device 12 so that the user can review the product data. If no promotions are associated with the product, or the mobile application 34 otherwise determines that no additional queries need be made, this step may occur without transmitting the third query 94 to the e-business platform 14. The third query 94 is thus optional, and is only sent in response to suitable system conditions being met, such as the aforementioned promotion flag being set in the second query response 113.

Although illustrated in FIG. 2 and described above as a linear sequence, persons having ordinary skill in the art will understand that the mobile application 34 may launch queries 92, 94, 96 in a different sequence or concurrently, and likewise may receive query responses 103, 105, 113 at any time. Moreover, additional functions and queries may be performed during the data retrieval process. For example, the user may proceed to other parts of the mobile application while data is being retrieved. Certain data that is relatively stable, such as inventory rules, may be cached in the memory 24 of mobile device 12 to reduce the amount of data traffic required between the wireless data network 18 and mobile application 34. Caching of data in the mobile application 34 may also allow the mobile application 34 to operate more efficiently, and/or continue to operate during a temporary absence of the wireless communication link 36. Embodiments of the invention are thus not limited to performing the shown functions in a particular sequence, or storing data in a particular location.

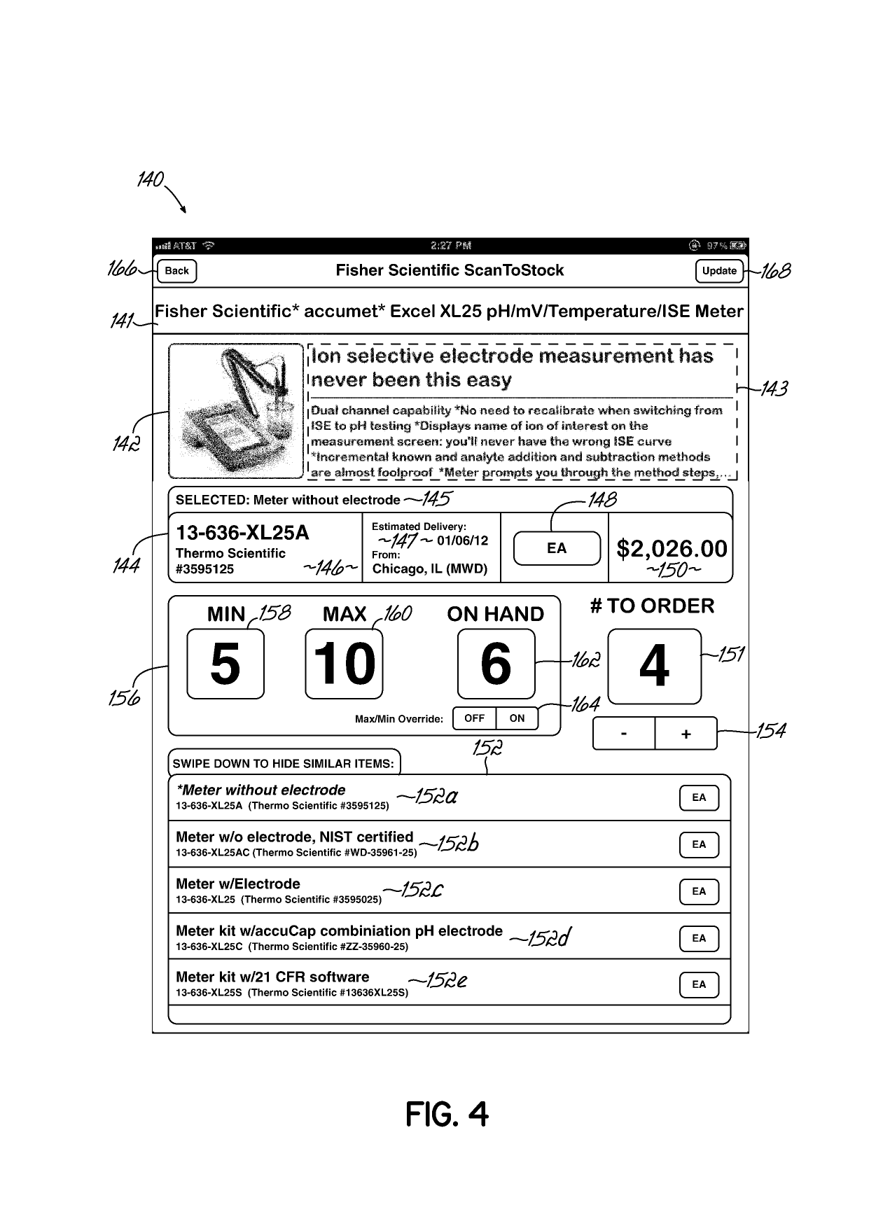

Once the mobile application 34 has obtained the desired product description, pricing, inventory, and promotion data, the data is displayed through the user interface 28 of the mobile device 12. An exemplary presentation of this data is shown by a product page 140 illustrated in FIG. 4. Product page 140 may include a headline 141 that identifies the manufacturer and/or vendor of the product as well as the name of the product. Below the headline 141, the product page 140 includes an image of the product 142, a product description 143, a product price and availability window 144, an order amount window 151, and a related product list 152 of products or items 152a-152e related to the displayed product.

The product price and availability window 144 includes a brief selected product description 145, a product identity window 146 that includes a stock keeping unit (SKU) number and a vendor part number, an availability window 147 that displays data regarding estimated delivery date and product location, a unit selection button (e.g., each, pack, case, kg) 148, a price window 150 that displays the price of the selected unit, and a recommended order calculation window 156.

The items included in the related product list 152 may be determined from data supplied to the mobile application 34 by the e-business application 62, and may include items that are typically ordered along with the displayed product, substitutes for the displayed product, items having different features or options than the displayed product, and items that are part of a current promotion. Moreover, although five items 152a-152e are shown in FIG. 4, it should be understood that any number of related items 152a-152e may be included in the related product list 152, and embodiments of the invention are not limited to a particular number of related items 152a-152e. The number of items displayed in the order amount window 151 may be either added or subtracted from an order by activating the associated “+” or “−” side of the order modification button 154. The order modification button 154 thereby provides a mechanism by which the user may selectively add or delete the displayed item from an order.

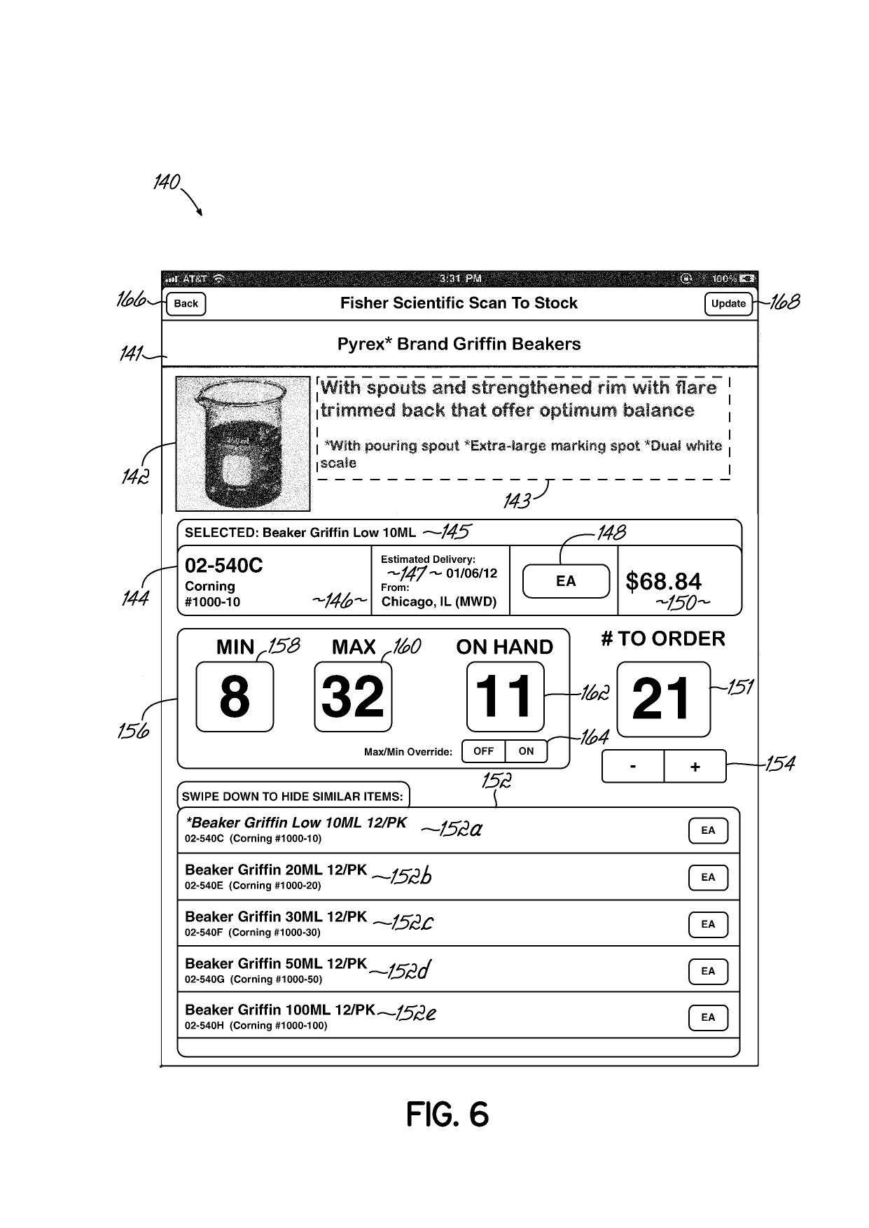

The recommended order calculation window 156 includes a recommended minimum inventory amount window 158, a recommended maximum inventory amount window 160, a window for entering the amount of product on hand 162, and a minimum/maximum override button 164, which are described in more detail below with respect to FIG. 6. The product page 140 may also include a back button 166 that returns the user to the previous page, and an update button 168 that refreshes the page with the latest data available.

In block 84, the user reviews the data displayed by the product page 140. The user may add or subtract the amount of the product displayed in the order amount window 151 to the order by activating either the “+” or “+” side of the order modification button 154, respectively. To add or remove an item 152a-152e on the related product list 152 from the order, the user may click on or otherwise select the desired item 152a-152e. In response to the user selecting the item 152a-152e, the mobile application 34 may retrieve data related to the selected item in a similar manner as described with respect to scanning the machine readable code 31. The mobile application 34 may then, in turn, display the retrieved data on a new product page 140 in essentially the same manner as described above.

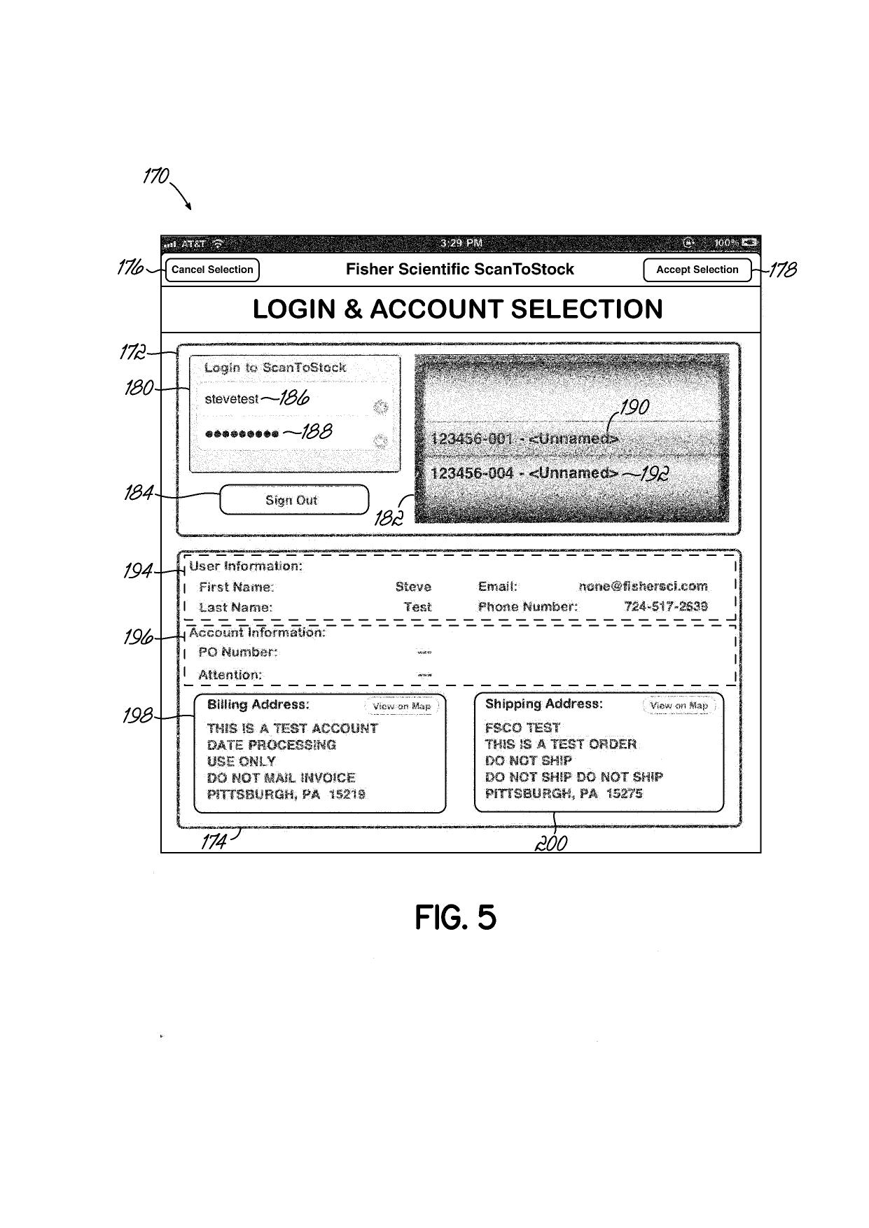

Once the user has finished reviewing the product page 140, the mobile application 34 may return the user to the home page 120. From the home page 120, the user may select another product to scan as previously described, or may log into the system by activating the login button 126. In response to the user activating the login button 126, the mobile application may display a login page 170 as shown in FIG. 5. The login page 170 may include a login window 172, an account information window 174, a cancel selection button 176, and an accept selection button 178. The login window 172 may further include an account sign in window 180, an account selection window 182, and an account sign out button 184.

To log into an account, the user enters a username and password into the account sign in window 180 and selects an account number 190, 192 from the account selection window 182. If the user is satisfied with their entry, the user may activate the accept selection button 178, or provide some other suitable input such as by activating an “enter” button on the user interface 28 of mobile device 12. In response to activation of the accept selection button 178, the mobile application 34 will check the user name 186 and password 188 against the selected account number 190, 192. If the user enters a valid username 186 and password 188, the mobile application 34 signs the user into the selected account 190, 192. If not, the mobile application 34 denies the user access.

Once the user has successfully logged in to an account, the mobile application 34 may populate the account information window 174 with user information 194 and account information 196. The account information 196 may further include a billing address window 198 and a shipping address window 200. View-on-map buttons 202, 204 associated with the billing and shipping address windows 198, 200 may allow the user to pull up a map of the associated address by activating the respective button 202, 204. Orders submitted through the mobile application 34 will thus be charged and shipped to the account listed. After logging in, the user may continue to add items to the order by scanning machine codes and adding items to the order as described above. To this end, the user may scan a machine readable code 31 for an item that is normally carried in inventory.

Referring now to FIG. 6, a product page 140 is illustrated for an item carried in inventory, such as a beaker. To aid the user in ordering a proper amount of the item, minimum and maximum inventory amount data that reflects inventory rules specific to that stockroom may be displayed by the mobile application 34. In an embodiment of the invention, the minimum and maximum inventory amount data is embedded in the machine readable code 31, and the mobile application 34 determines the minimum and maximum inventory amounts directly from the scanned data. However, in an alternative embodiment of the invention, the minimum and maximum inventory amount data may be provided from a customer specific or stockroom specific database hosted by one or more of the e-business platform 14, product inventory system 16, and/or a separate customer specific database (not shown), such as a cloud based database within the data network 20.

Once the minimum and maximum values have been determined, the mobile application 34 displays this data in the minimum and maximum inventory windows 158, 160 respectively. The system user determines the number of items currently in inventory, such as by a visual inspection of the area in which the item is stored, and enters the number of items on hand in the on hand inventory window 162. The mobile application 34 may then automatically populate the order amount window 151 using inventory rules specific to that stockroom. Typically, the mobile application 34 performs this automatic order amount function by determining the difference between the amount of product on hand and the maximum desired inventory amount. The mobile application 34 then populates the order amount window 151 with the difference. Embodiments of the invention may also allow the system user to return or reallocate product if the amount of product in inventory exceeds the maximum desired amount. This situation could occur, for example, if the maximum desired inventory amount was adjusted downward due to a change in demand at the customer location. In the example page illustrated in FIG. 6, the order amount window 151 is thus populated with the difference (21) between the number of beakers on hand (11) and the maximum number of beakers desired for on hand inventory (32). Inventory rules may also be established that base the amount of the product to order on the minimum desired inventory amount, or a combination of the minimum and maximum desired inventory amounts. By way of example, the order amount function may be configured to not add an item to an order until the amount on hand drops below the minimum desired inventory amount, at which point an amount is added based on the maximum desired inventory amount. The invention is thus not limited to a particular automatic order amount function or set of inventory rules.

If the user does not wish to add the recommended amount of the product to the order, the user may deactivate the function using the override button 164. The user may then directly enter a number into the order amount window 151, and add or subtract this amount from the order using the order modification button 154.

When determining the number of items to add to the order, the mobile application 34 may also take into account the amount of the item that has been ordered, but not yet delivered—i.e., a back-order amount. This back-order amount may, in turn, be subtracted from the order amount so that the amount of the first product in inventory does not exceed the maximum desired inventory amount when the back ordered product is delivered. Data regarding back-order amounts may be supplied to the mobile application 34 as part of the real-time data received from the product inventory system 16.

Advantageously, by presenting this data to the user on the mobile device 12, the user may scan the machine readable code 31 and count the number of items on hand in the area of the stockroom where the items are stored. More advantageously, because the mobile application 34 is provided with real-time data by the e-business platform 14 and the product inventory system 16, the order amount window 151 may be automatically populated with an amount that reflects items on order that have not yet been received in the stockroom. The ability to scan items and retrieve real-time data in a mobile environment thus greatly reduces the time and effort involved in replenishing existing stock, as well as increasing the accuracy of the order. The user may thereby assemble an order by moving through the stockroom and scanning machine readable codes associated with each product carried.

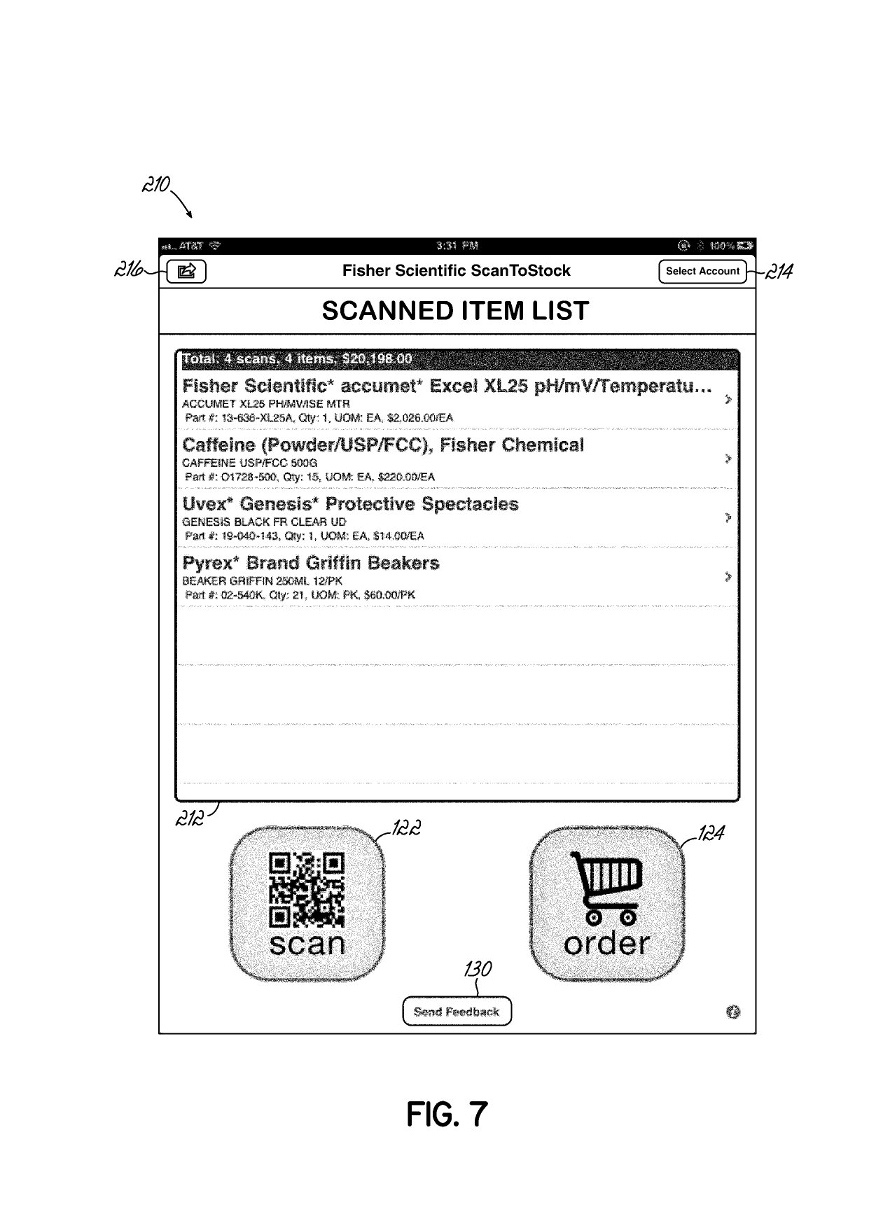

Referring now to FIG. 7, in response to one or more items being added or deleted from the order, the mobile application 34 may display a scanned item list page 210 on the user interface 28 of the mobile device 12. The scanned item list page 210 includes the product scan button 122, order button 124, feedback button 130, and a scanned item list 212. The scanned item list page 210 may also include a select account button 214 and a previous page button 216, which returns the user to the previously viewed page. The select account button 214 may allow the user to switch accounts during the inventory restocking process so that inventory that is segregated into separate accounts may nonetheless be replenished during a single trip through the stockroom.

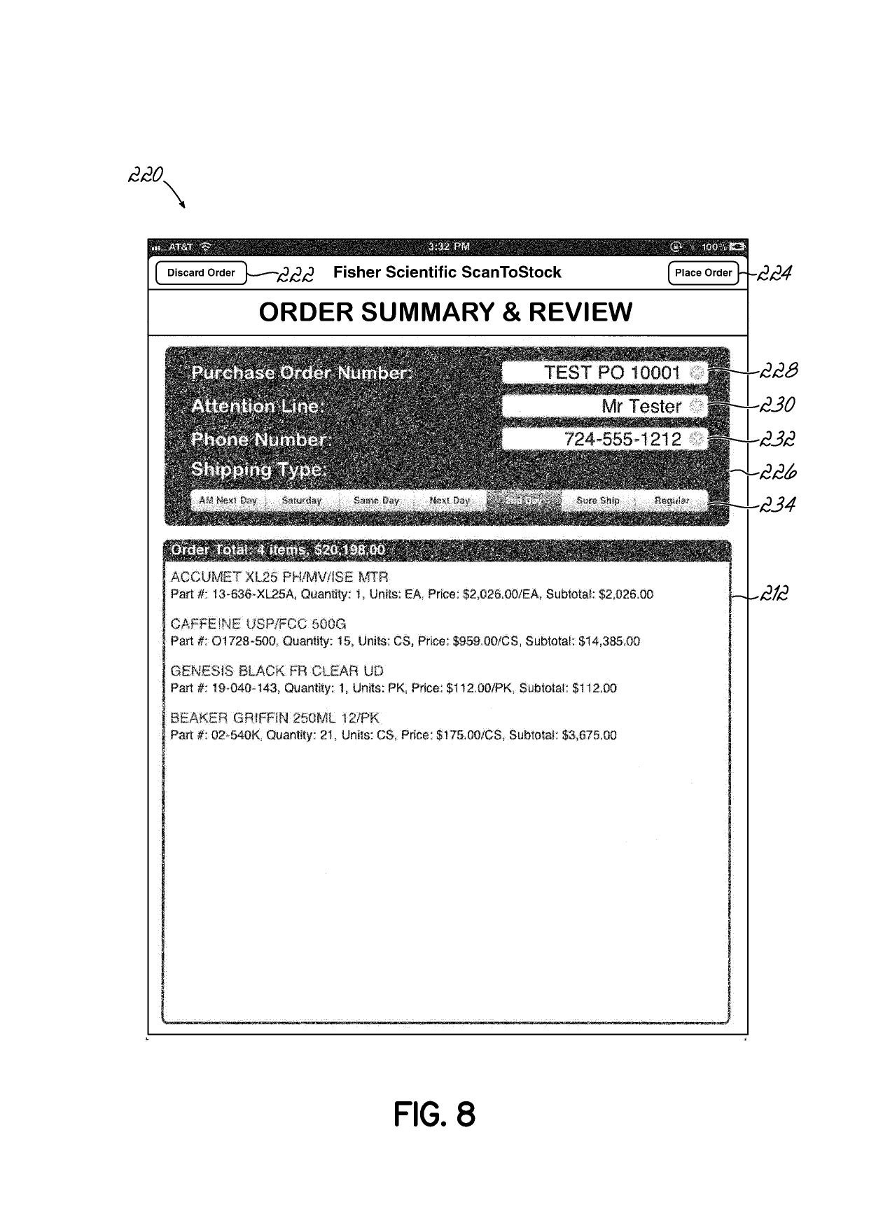

When there are no more items to be replaced (“No” branch of decision block 86), the user may activate the order button 124. In response to the user activating the order button 124, the mobile application 34 may display an order summary and review page 220 (FIG. 8). The summary and review page 220 may include the scanned item list 212, a discard order button 222, a place order button 224, and a requisition window 226. The requisition window 226 may include a purchase order number 228, an attention line window 230 that lists the account holder for the account under which the order is being submitted, a phone number window 232 that lists a contact number for the account holder, and a shipping bar 234 that provides shipping options for the order. If the user is satisfied with the order, the user may activate the place order button 224.

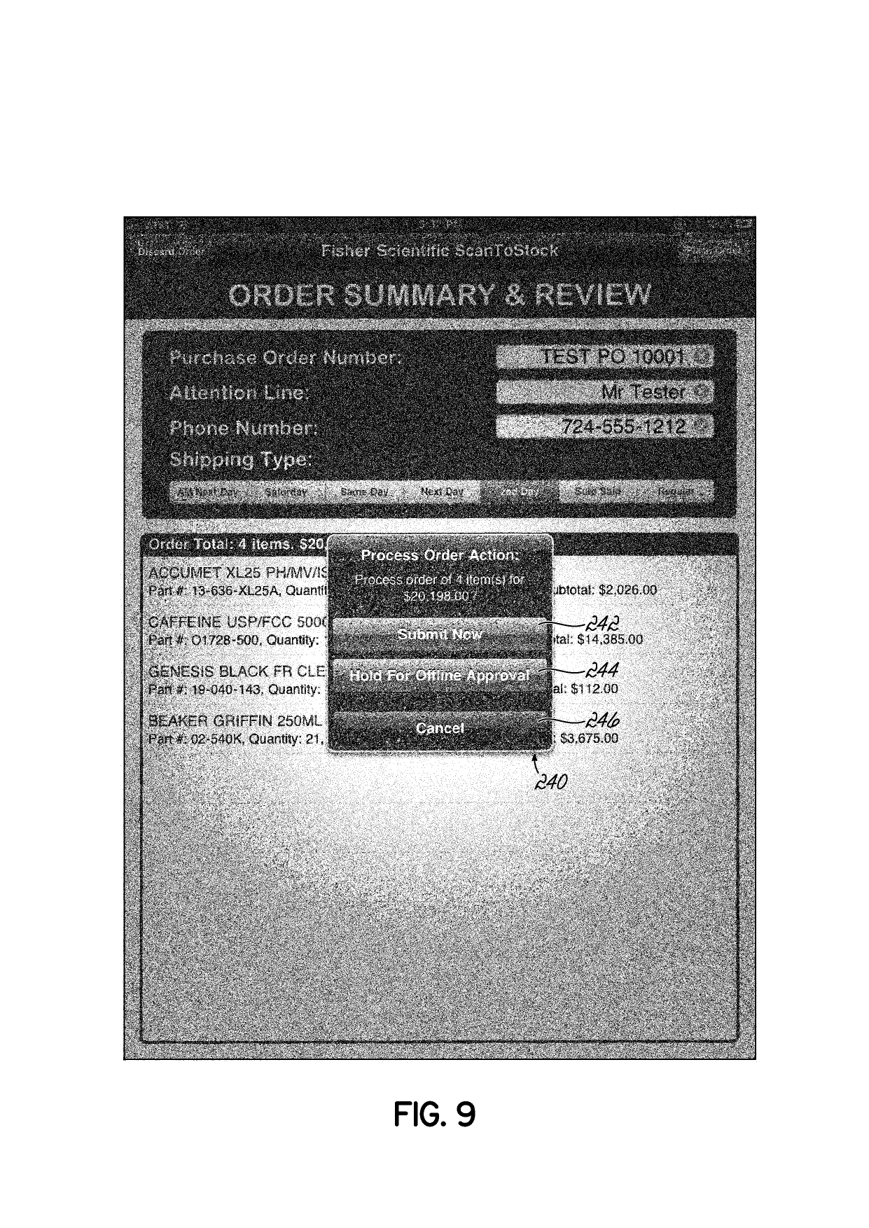

Referring now to FIG. 9, in response to the user activating the place order button 224, the mobile application 34 may cause the user interface 28 of the mobile device 12 to display a process order action pop-up window 240. The pop-up window 240 may include a submit order now button 242, a hold order button 244, and a cancel order button 246. If the user decides to submit the order (“Yes” branch of decision block 87), the user may activate the submit order button 242 (block 88). In response to activation of the submit order button 242, the mobile application 34 proceeds to block 98.

In block 98, the mobile application 34 captures the order specific details and generates a suitably formatted order request 99 that is transmitted to the e-business platform 14. In response to receiving the order request 99, the e-business application 62 may proceed to block 106 and process the order by scheduling shipment and debiting the proper accounts. The e-business application 62 may also generate and transmit an inventory update request 108 to the product inventory system 16. In response to receiving the inventory update request 108, the product inventory application 68 may proceed to block 114. In block 114, the product inventory application 68 may update the inventory and supply chain data to reflect the newly processed order. The e-business and product inventory databases 58, 64 are thereby updated in real time so that system users are supplied with accurate data.

If the user activates the hold order button 244, (“Hold” branch of decision block 87), the mobile application may proceed to block 97 where the order is saved for later submission. This choice might be selected, for example, if the user has not finished scanning all the items in the stockroom at the end of a shift. The user may open up the saved order at a later time for submission, or to add additional items. Finally, the user may activate the cancel order button 246, which aborts the ordering process.

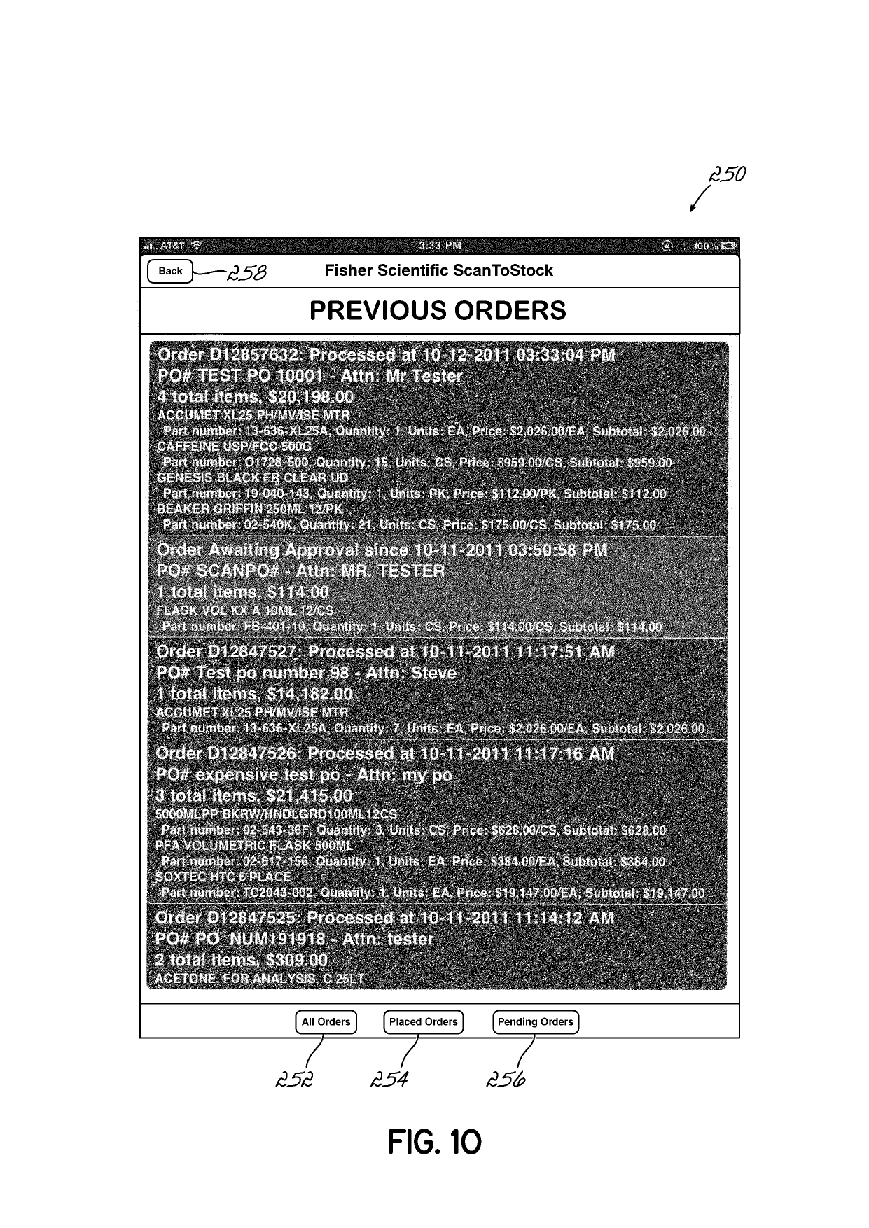

Referring now to FIG. 10, the mobile application 34 may maintain a list of previously submitted orders as well as orders that are on hold. This list may be displayed in a previous order page 250 by the mobile application 34 in response to an order being submitted, saved for later submission, or cancelled. In addition to information regarding previous orders, the previous order page 250 may include an all orders button 252, a placed orders button 254, and a pending orders button 256. In response to the user activating these buttons, the mobile application 34 may filter the orders displayed on the previous order page 250. The user may thereby view all existing orders by activating the all orders button 252, view only orders that have been placed by activating the placed orders button 254, and view only pending orders by activating the pending orders button 256. The previous orders page 250 may also include a back button 258 that, upon activation, causes the mobile application 34 to display the previously viewed page.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details of the representative apparatus and method, and illustrative examples shown and described. Accordingly, departures may be made from such details without departing from the spirit or scope of applicants' general inventive concept.

What is claimed is:

1. A method of replenishing product inventory in a stockroom, the method comprising:
in response to a first input into a user interface of a mobile device, scanning a machine readable code associated with a product with the mobile device to identify the product; and
determining a desired inventory amount based at least in part on data contained in the machine readable code.

2. The method of claim 1 wherein the desired inventory amount is a desired maximum inventory amount.

3. The method of claim 1 wherein the desired inventory amount is a desired minimum inventory amount.

4. The method of claim 1, wherein the desired inventory amount is included in the data contained in the machine readable code, and the machine readable code is associated with a storage area of the product being replenished.

5. The method of claim 4 wherein the machine readable code is affixed to an area in which the product is stored.

6. The method of claim 1 further comprising:
in response to scanning the machine readable code, querying a first database to obtain first data relating to the product, wherein the desired inventory amount is determined based at least in part on the first data.

7. The method of claim 6 further comprising:
querying a second database, different than the first database, to obtain second data relating to the product; and
displaying the first and second data relating to the product on the user interface of the mobile device.

8. The method of claim 7 wherein the second data comprises pricing data.

9. The method of claim 6 wherein the first data comprises image and textual data.

10. The method of claim 1, further comprising:
in response to a second input into the user interface of the mobile device, generating an order including the product, the amount of the product included in the order being based at least in part on the desired inventory amount.

11. The method of claim 10, further comprising:
in response to a third input into the user interface of the mobile device, submitting the order to a product inventory system, wherein the product inventory system updates data relating to the product in response to receiving the order.

12. The method of claim 1 wherein determining the desired inventory amount includes extracting the desired inventory amount from the data contained in the machine readable code.

13. The method of claim 1, further comprising:
calculating a desired order amount based at least in part on the desired inventory amount;
displaying an order amount window on the user interface of the mobile device; and
automatically populating the order amount window with the desired order amount.

14. The method of claim 13 wherein calculating a desired order amount based at least in part on the desired inventory amount includes taking into account an amount of the product that is on back-order.

15. A requisition and inventory management system for restocking inventory, the system comprising:
a processor; and
a memory, the memory storing instructions that, when executed by the processor, cause the processor to:
in response to a first input into a user interface of a mobile device, scan a machine readable code associated with a product to identify the product; and
determine a desired inventory amount based at least in part on data contained in the machine readable code.

16. The system of claim 15, wherein the desired inventory amount is included in the data contained in the machine readable code, and the machine readable code is associated with a storage area of the product being replenished.

17. The system of claim 15 wherein the instructions further cause the processor to:
in response to scanning the machine readable code, query a first database to obtain first data relating to the product, wherein the desired inventory amount is determined based at least in part on the first data.

18. The system of claim 17 wherein the instructions further cause the processor to:
query a second database, different than the first database, to obtain second data relating to the product; and
display the first and second data relating to the product on the user interface of the mobile device.

19. The system of claim 15 wherein the instructions further cause the processor to:
in response to a second input into the user interface of the mobile device, generate an order including the product, the amount of the product included in the order being based at least in part on the desired inventory amount.

20. The system of claim 15 wherein the instructions cause the processor to determine the desired inventory amount by extracting the desired inventory amount from the data contained in the machine readable code.

21. The system of claim 15 wherein the instructions further cause the processor to:
calculate a desired order amount based at least in part on the desired inventory amount;
display an order amount window on the user interface of the mobile device; and
automatically populate the order amount window with the desired order amount.

22. The system of claim 21 wherein calculating a desired order amount based at least in part on the desired inventory amount includes taking into account an amount of the product that is on back-order.

23. A computer program product comprising:
a non-transitory computer readable storage medium; and
program instructions stored on the computer readable storage medium that, when executed by a processor, cause the processor to:
in response to a first input into a user interface of a mobile device, scan a machine readable code associated with a product to identify the product; and
determine a desired inventory amount based at least in part on data contained in the machine readable code.
